(19) United States
(12) Patent Application Publication
(10) Pub. No.: US 2016/0078285 A1
(43) Pub. Date: Mar. 17, 2016

(54) System and Method for Displaying an Object in a Tagged Image

(71) Applicant: Roshni Malani, Irvine, CA (US)

(72) Inventor: Roshni Malani, Irvine, CA (US)

(21) Appl. No.: 13/478,365

(22) Filed: May 23, 2012

(51) Int. Cl. G09G 5/00; G09G 5/14; G06F 3/0481; G06F 3/0484

(52) U.S. Cl. CPC G06K 9/00295; G06F 3/04842; G06K 9/00228; G09G 5/14; G06F 3/0481; G09G 2340/12

(57) ABSTRACT

A request to display a first object that is within a displayed image and obscured by a second object displayed over the first object is detected. A second image comprising the first object is generated, and the second image is displayed over the second object. The second object may include a tag associated with a third object in the image, for example. The first object may be a face of an individual displayed in the image, for example.

### TECHNICAL FIELD

This specification relates generally to systems and methods for displaying images, and more particularly to systems and methods for displaying an object in a tagged image.

### BACKGROUND

The increased use of social networking websites has facilitated the growth of user-generated content, including images and photographs, on such websites. Many users place personal photographs and images on their personal web pages, for example. Many social networking websites additionally allow a user to place tags onto a photograph or image, for example, to identify individuals in a photograph. A tag containing an individual's name may be added next to the individual's image in a photograph, for example. Some sites allow a user to post a photograph or image (and to tag the photograph or image) on the personal web page of another user.

### SUMMARY

In accordance with an embodiment, a method of displaying an object in an image is provided. A request to display a first object that is within a displayed image and obscured by a second object displayed over the first object is detected. A second image comprising the first object is generated, and the second image is displayed over the second object. The second object may include a tag associated with a third object in the image.

In one embodiment, the first object in the second image is aligned with the first object in the displayed image.

In one embodiment, the first object is a face of an individual in the image, and the second object is a tag associated with a second individual in the image. The tag may include a name of the second individual.

In another embodiment, a second image comprising the face of the individual is generated, wherein the second image has a predetermined size.

In one embodiment, the presence of a cursor above the first object during a predetermined period of time is detected, and a determination is made that the presence of the cursor above the first object during the predetermined period of time constitutes a request to display the first object.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to provide image processing services in accordance with an embodiment;

FIG. 2 shows components of an exemplary user device;

FIG. 3 shows functional components of a website manager in accordance with an embodiment;

FIG. 4 shows a web page that includes an image of various individuals in accordance with an embodiment;

FIG. 5 shows the web page of FIG. 4 after tags have been added to the image in accordance with an embodiment;

FIG. 6 is a flowchart of a method of displaying an object within an image in accordance with an embodiment;

FIG. 7 shows the web page of FIG. 4 after a selected object obscured by a tag has been displayed in accordance with an embodiment; and

FIG. 8 shows components of a computer that may be used to implement certain embodiments of the invention.

### DETAILED DESCRIPTION

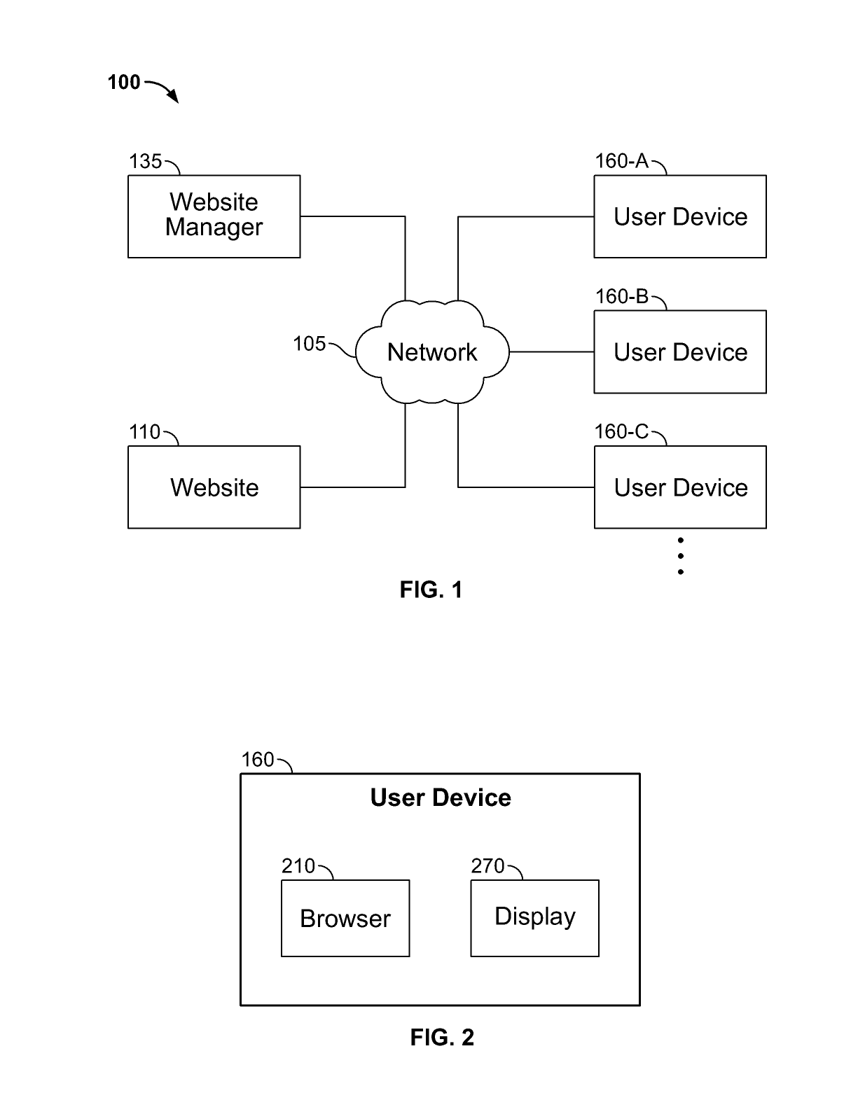

FIG. 1 shows a communication system 100 that may be used to provide image processing services in accordance with an embodiment. Communication system 100 includes a network 105, a website manager 135, a website 110, and several user devices 160-A, 160-B, 160-C, etc. For convenience, the term “user device 160” is used herein to refer to any one of user devices 160-A, 160-B, etc. Accordingly, any discussion herein referring to “user device 160” is equally applicable to each of user devices 160-A, 160-B, 160-C, etc. Communication system 100 may include more or fewer than three user devices.

In the exemplary embodiment of FIG. 1, network 105 is the Internet. In other embodiments, network 105 may include one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may include a combination of different types of networks.

Website 110 is a website accessible via network 105. Website 110 comprises one or more web pages containing various types of information, such as articles, comments, images, photographs, etc.

Website manager 135 manages website 110. Website manager 135 accordingly provides to users of user devices 160 access to various web pages of website 110. Website manager 135 also provides other management functions, such as receiving comments, messages, images, and other information from users and posting such information on various web pages of website 110.

User device 160 may be any device that enables a user to communicate via network 105. User device 160 may be connected to network 105 through a direct (wired) link, or wirelessly. User device 160 may have a display screen (not shown) for displaying information. For example, user device 160 may be a personal computer, a laptop computer, a workstation, a mainframe computer, etc. Alternatively, user device 160 may be a mobile communication device such as a wireless phone, a personal digital assistant, etc. Other devices may be used.

FIG. 2 shows functional components of an exemplary user device 160 in accordance with an embodiment. User device 160 comprises a web browser 210 and a display 270. Web browser 210 may be a conventional web browser used to access World Wide Web sites via the Internet, for example. Display 270 displays documents, Web pages, and other information to a user. For example, a web page containing text, images, etc., may be displayed on display 270.

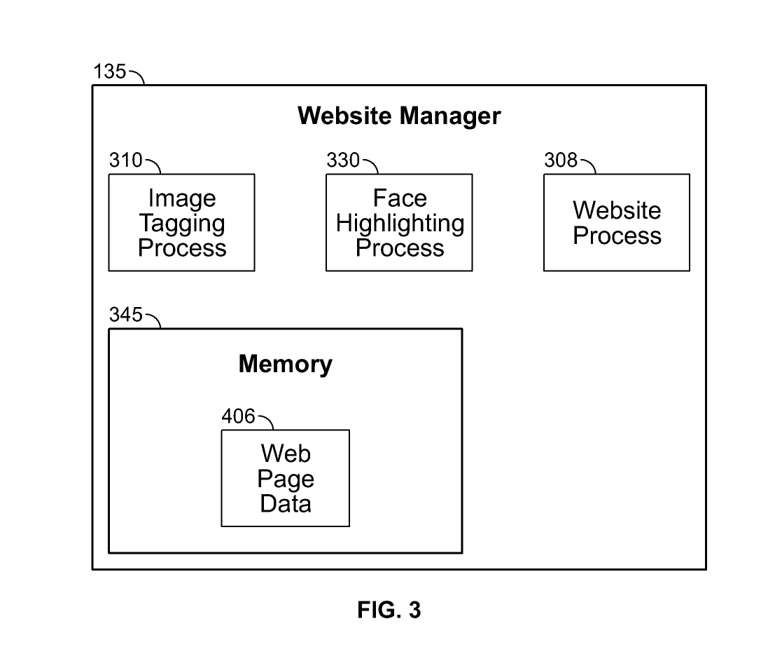

FIG. 3 shows functional components of website manager 135 in accordance with an embodiment. Website manager 135 comprises an image tagging process 310, a face highlighting process 330, a website process 308, and a memory 345. Website process 308 generates and maintains website 110 and various web pages of website 110. Website process 308 enables users to access website 110 and various web pages within the website. For example, website process 308 may receive from a user device 160 a uniform resource locator associated with a web page of website 110 and direct the user device 160 to the web page. Website process 308 may additionally receive from a user device 160 a comment or an image that a user wishes to add to a web page (such as a personal web page, a blog, etc.), and post the comment or image on the desired web page.

Image tagging process 310 receives information from a user concerning an object, such as a face, in an image, and generates a tag for the object based on the information. For example, image tagging process 310 may receive from a user a selection of a face in an image displayed on a web page, and receive a name associated with the face. In response, image tagging process 310 generates a tag showing the name and inserts the tag at an appropriate location in the image. A tag may be generated and inserted for any type of object in an image, such as a building, an automobile, a plant, an animal, etc.

Face highlighting process 330, from time to time receives an indication of an object in an image, such as a face, that is obscured by a tag, and in response, generates a second image of the object and displays the second image. In one embodiment, face highlighting process 330 includes facial recognition functionality. Accordingly, face highlighting process 330 is configured to analyze image data and identify a face within the image. Face highlighting process 330 may therefore identify a face in an image and determine the size of the face. Facial recognition functionality is known.

Memory 345 stores data. Memory 345 may be used by other components of website manager 135 to store various types of data, images, and other types of information.

In an illustrative embodiment, website 110 is a social networking website that allows a first user to construct his or her own web page and add content such as text, images, photos, links, etc., to the web page. Website 110 may also allow a second user to visit the first user's web page and insert additional content, including text, images, photos, etc.

In accordance with the embodiment of FIG. 1, a user may access website manager 135 and create and/or edit a web page. For example, a user may employ browser 210 to access website manager 135 and create a web page on website 110. In a well-known manner, the user may be required to log into a user account to create and/or access website 110. The user may be required to authenticate his or her identity, e.g., by entering a user name and password, before accessing website 110.

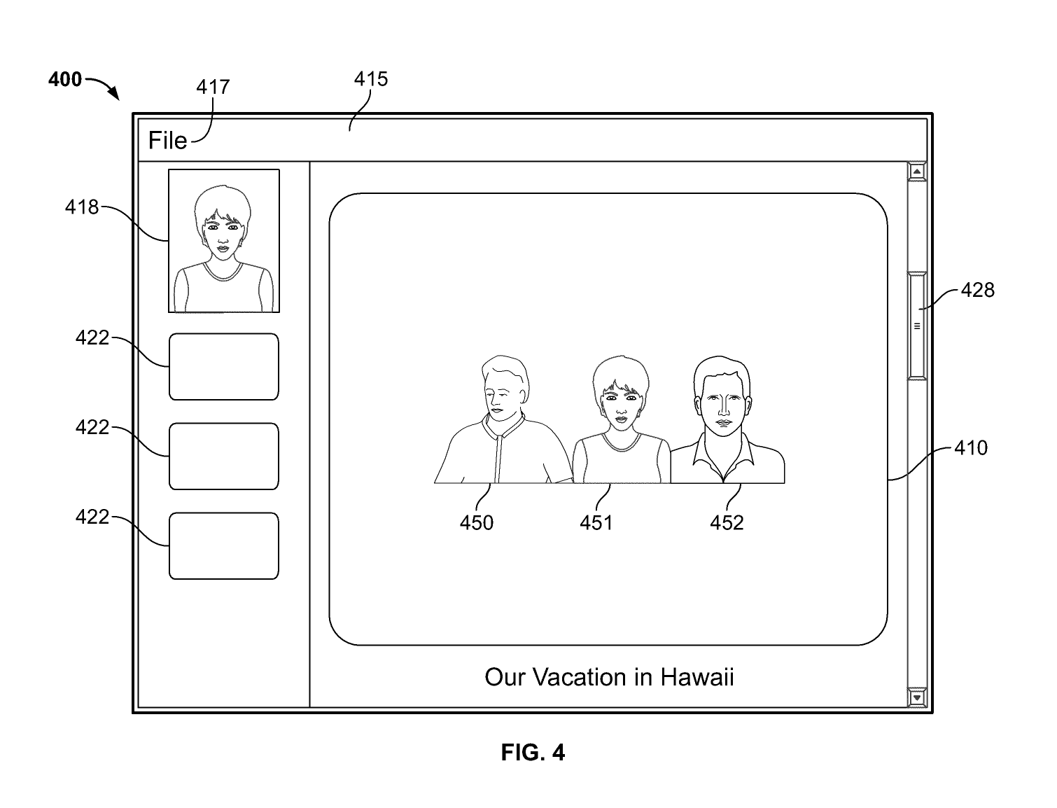

Suppose, for example, that a user of user device 160-A employs browser 210 to access website manager 135, and creates a new web page, such as web page 400 illustrated in FIG. 4. Website manager 135 stores data related to the new web page in memory 345 as web page data 406, as shown in FIG. 3.

To enable the user to view and edit web page 400, website manager 135 transmits data causing user device 160 to display a representation of all or a portion of the web page on display 270, in a well-known manner. For example, website manager 135 may transmit to browser 210 a request, in the form of HyperText Markup Language (HTML), adapted to cause browser 210 to display a representation of web page 400. In response, browser 210 displays a representation of all or a portion of web page 400. Referring to FIG. 4, browser 210 also displays a toolbar 415 which may display various available options and/or functions available to the user, such as a file function 417. Browser 210 also displays a scrollbar 428 to enable the user to scroll up or down within the web page. If the user adds content to the web page, web page data 406, stored in memory 345, is updated.

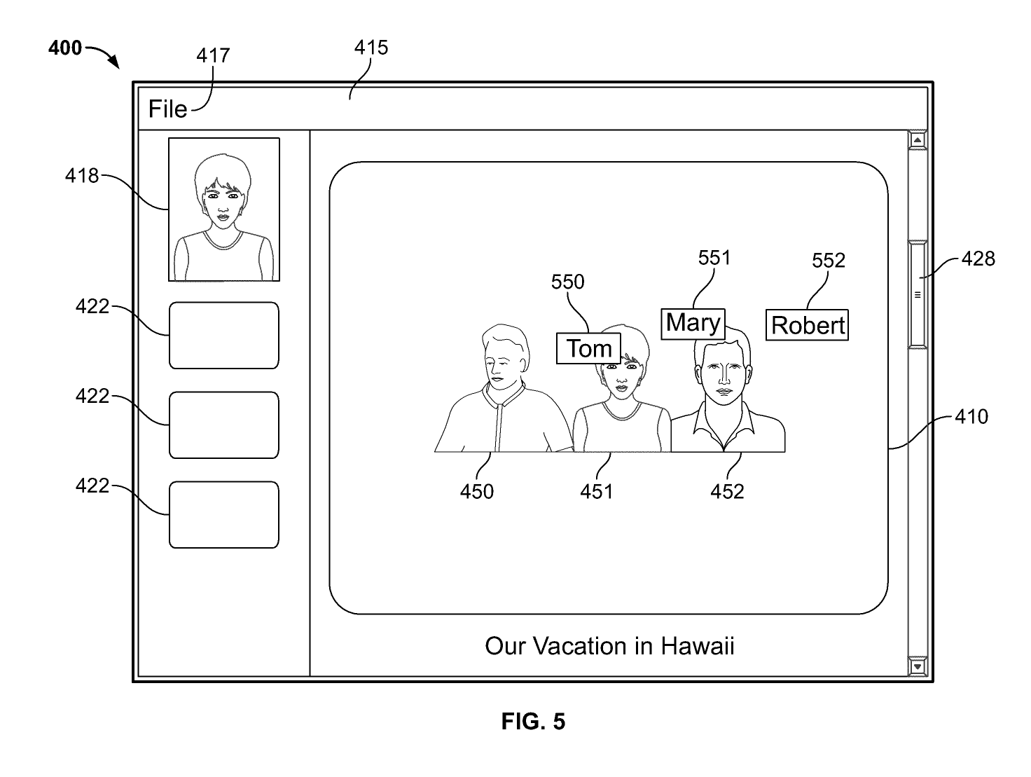

In the illustrative embodiment, the first user adds to web page 400 an image 418, several comments 422, and a photograph 410 of several individuals 450, 451, and 452. The first user inserts the text “Our vacation in Hawaii” below photograph 410. The first user additionally adds tags containing the three individuals' respective names to web page 400. Image tagging process 310 receives from the first user the names of the three individuals in the photograph and inserts tags in selected locations in the photograph, as shown in FIG. 5. Specifically, a tag 550 with the name “Tom” is placed beside the face of individual 450, a tag 551 with the name “Mary” is placed beside the face of individual 451, and a tag 552 with the name “Robert” is placed beside the face of individual 452. In this illustrative embodiment, tag 550 partially obscures the face of individual 451, and tag 551 partially obscures the face of individual 452.

Now suppose that a second user, employing user device 160-B, accesses website manager 135 and gains access to web page 400. In particular, the second user wishes to view photograph 410. The second user accordingly scrolls down the web page until photograph 410 is in view; however, the second user finds that tag 550 partially obscures the face of individual 451, and that tag 551 partially obscures the face of individual 452.

In accordance with an embodiment, the second user may select an option to highlight a face in the photograph that is obscured by a tag. For example, wishing to view the face of individual 451, which is obscured by tag 550, the second user may request that the face of individual 451 be displayed by selecting the face of the individual. For example, the second user may select the face of individual 451 by moving a cursor over the face and causing the cursor to “hover” over the face (i.e., causing the cursor to remain above the selected face for a predetermined period of time). Upon detecting the presence of the cursor above the face during the predetermined period, website manager 135 determines that the second user has selected the face of individual 451 and highlights the face of individual 451. Systems and methods for highlighting a face of an individual that is obscured by a tag are described below.

While the discussion below, and the illustrative embodiments shown in the Figures, describe systems and methods for highlighting a face obscured by a tag, the discussion herein and the illustrative embodiments are not intended to be limiting. Systems and methods described herein may be used to display any first object within an image that is obscured by a second object displayed over the first object. For example, any object, such as an image of a building obscured by a tag, an image of an automobile obscured by an advertisement, etc., may be selected by a user and displayed using the systems and methods described herein.

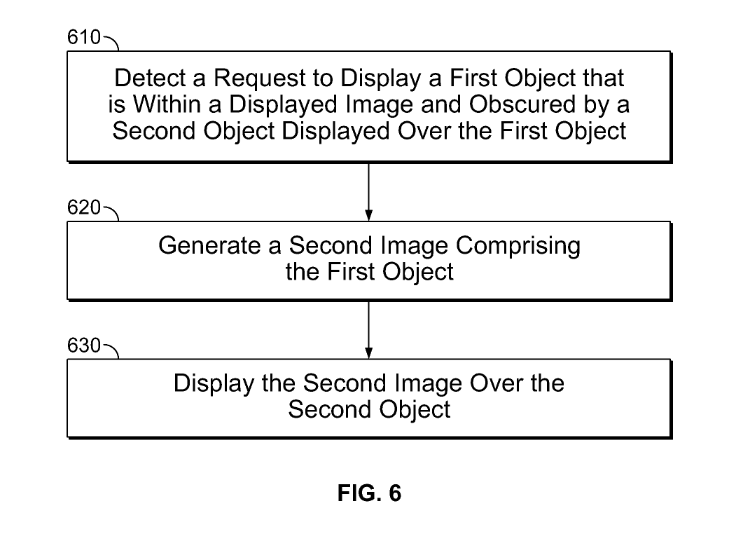

FIG. 6 is a flowchart of a method of displaying an object within an image that is obscured by a second object in accordance with an embodiment. At step 610, a request to display a first object that is within a displayed image and obscured by a second object displayed over the first object is detected. In the illustrative embodiment discussed above, the second user, wishing to view the face of individual 451 (which is obscured by tag 550), requests that the face of individual 451 be displayed by moving a cursor over the face and causing the cursor to “hover” over the face (remain above the face for a predetermined period of time). Upon detecting the presence of the cursor above the face of individual 451 during the predetermined period of time, face highlighting process 330 (of user device 160) determines that the presence of the cursor above the face during the predetermined period of time constitutes a request to display the face of individual 451. In other embodiments, other techniques may be used to detect a request to display a face. For example, in one embodiment, when a user double-clicks on a particular face in an image, highlight process 330 considers the user's clicking on the face to be a request to display the face.

At step 620, a second image comprising the first object is generated. Accordingly, face highlighting process 330 generates a second image comprising the face of individual 451, sized to fit into a shape of predetermined dimensions. Face highlighting process 330 may identify the individual's face (using facial recognition techniques), determine the size of the individual's face, and determine a second image size based on the size of the face (by adding a margin of a predetermined size around the face). Thus, for example, in one embodiment, face highlighting process 330 may generate a second image of the individual's face sized to fit into a one centimeter by one centimeter square. In another embodiment, face highlighting process 330 may generate a second image of the individual's face sized to fit into a rectangle of dimensions X pixels by Y pixels (for example, 300 pixels by 300 pixels). X and Y may be predetermined values, or may be values determined based on one or more characteristics of the image, or on other parameters. Alternatively, face highlighting process 330 may define a rectangle, square, or other shape, based on the size of the individual's face. Other sizes and shapes may be used.

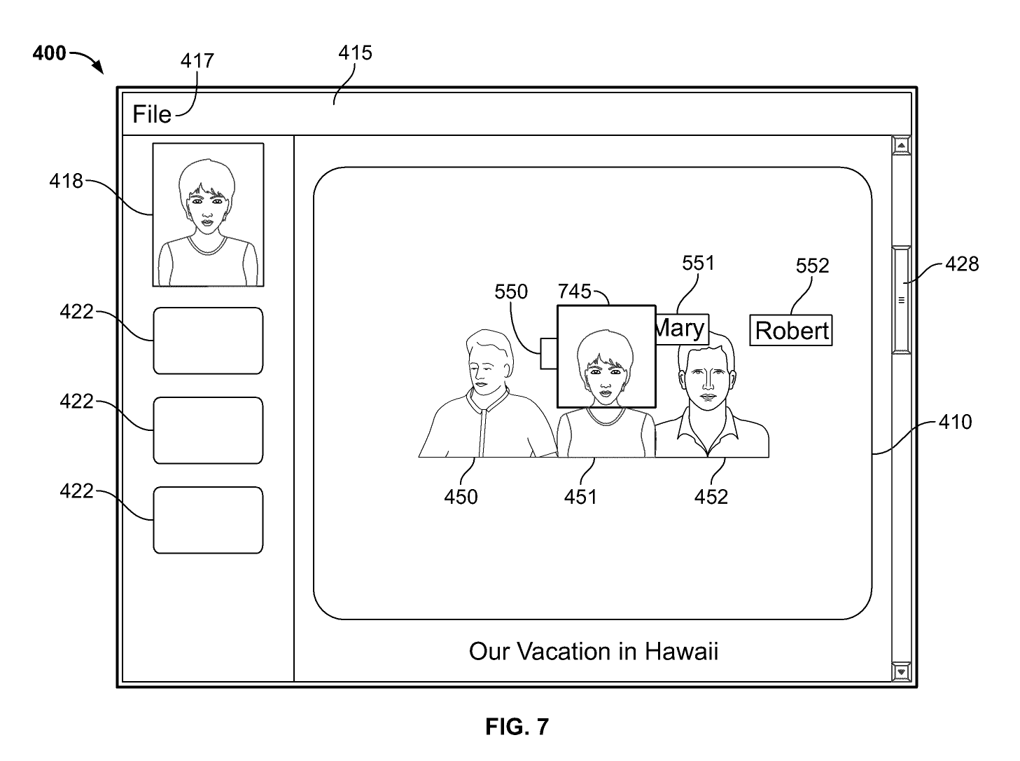

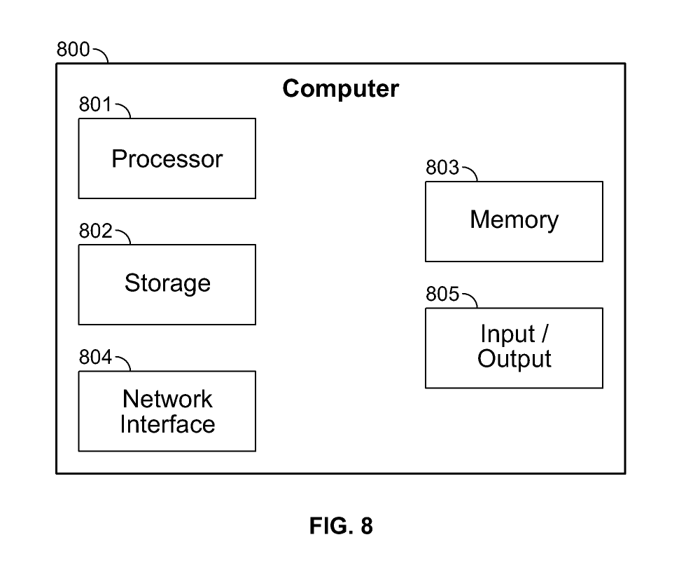

At step 630, the second image is displayed over the second object. Face highlighting process 330 displays the second image of the individual's face over tag 550. Referring to FIG. 7, an image of the face of individual 451 (Mary) is superimposed over image 410 and over tag 550. The second user may now clearly view the face of the individual as it is not obscured by any tag.

In one embodiment, the first object in the second image is aligned with the first object in the displayed image. Thus, face highlighting process 330 aligns the location and positioning of the individual's face in the second image with the original location and positioning of the individual's face in photograph 410.

In various embodiments, the method steps described herein, including the method steps described in FIG. 6, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 6. Certain steps of the methods described herein, including one or more of the steps of FIG. 6, may be performed by a server or by another processor in a network-based cloud-computing system. Certain steps of the methods described herein, including one or more of the steps of FIG. 6, may be performed by a client computer in a network-based cloud computing system. The steps of the methods described herein, including one or more of the steps of FIG. 6, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an exemplary computer that may be used to implement systems, apparatus and methods described herein is illustrated in FIG. 8. Computer 800 includes a processor 801 operatively coupled to a data storage device 802 and a memory 803. Processor 801 controls the overall operation of computer 800 by executing computer program instructions that define such operations. The computer program instructions may be stored in data storage device 802, or other computer readable medium, and loaded into memory 803 when execution of the computer program instructions is desired. Thus, the method steps of FIG. 6 can be defined by the computer program instructions stored in memory 803 and/or data storage device 802 and controlled by the processor 801 executing the computer program instructions. For example, the computer program instructions can be implemented as computer executable code programmed by one skilled in the art to perform an algorithm defined by the method steps of FIG. 6. Accordingly, by executing the computer program instructions, the processor 801 executes an algorithm defined by the method steps of FIG. 6. Computer 800 also includes one or more network interfaces 804 for communicating with other devices via a network. Computer 800 also includes one or more input/output devices 805 that enable user interaction with computer 800 (e.g., display, keyboard, mouse, speakers, buttons, etc.).

Processor 801 may include both general and special purpose microprocessors, and may be the sole processor or one of multiple processors of computer 800. Processor 801 may include one or more central processing units (CPUs), for example. Processor 801, data storage device 802, and/or memory 803 may include, be supplemented by, or incorporated in, one or more application-specific integrated circuits (ASICs) and/or one or more field programmable gate arrays (FPGAs).

Data storage device 802 and memory 803 each include a tangible non-transitory computer readable storage medium. Data storage device 802, and memory 803, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 805 may include peripherals, such as a printer, scanner, display screen, etc. For example, input/output devices 805 may include a display device such as a cathode ray tube (CRT) or liquid crystal display (LCD) monitor for displaying information to the user, a keyboard, and a pointing device such as a mouse or a trackball by which the user can provide input to computer 800.

Any or all of the systems and apparatus discussed herein, including website manager 135, user device 160, and components thereof, including browser 210, display 270, image tagging process 310, face highlighting process 330, website process 308, and memory 345 may be implemented using a computer such as computer 800.

One skilled in the art will recognize that an implementation of an actual computer or computer system may have other structures and may contain other components as well, and that FIG. 8 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of displaying an object in an image, comprising:
detecting a request to display a first object that is within a displayed image and obscured by a second object displayed over the first object;
determining, based on the detection of the request to display the first object, a size of the first object;
determining a size of a second image based on the size of the first object;
selecting a shape, from among multiple shapes, for the second image based on the size of the first object;
generating the second image comprising the first object, wherein the second image is sized to fit into the selected shape; and
displaying the second image over the second object and over the first object that is within the displayed image.

2. The method of claim 1, further comprising aligning the first object in the second image with the first object in the displayed image.

3. The method of claim 1, wherein the second object is a tag associated with a third object in the image.

4. The method of claim 3, wherein the first object is a face of an individual in the image.

5. The method of claim 4, wherein the second object is a tag associated with a second individual in the image.

6. (canceled)

7. The method of claim 1, wherein the detecting the request to display a first object comprises detecting the presence of a cursor hovering over the first object during a predetermined period of time.

8. (canceled)

9. A non-transitory computer readable medium having program instructions stored thereon, that, in response to execution by a computing device, cause the computing device to perform operations comprising:
detecting a request to display a first object that is within a displayed image and obscured by a second object displayed over the first object;
determining, based on the detection of the request to display the first object, a size of the first object;
determining a size of a second image based on the size of the first object;
selecting a shape, from among multiple shapes, for the second image based on the size of the first object;
generating the second image comprising the first object, wherein the second image is sized to fit into the selected shape; and
displaying the second image over the second object and over the first object that is within the displayed image.

10. The non-transitory computer readable medium of claim 9, further comprising program instructions that cause the computing device to perform operations comprising:
aligning the first object in the second image with the first object in the displayed image.

11. The non-transitory computer readable medium of claim 9, wherein the second object is a tag associated with a third object in the image.

12. The non-transitory computer readable medium of claim 11, wherein the first object is a face of an individual in the image.

13. The non-transitory computer readable medium of claim 12, wherein the second object is a tag associated with a second individual in the image.

14. (canceled)

15. The non-transitory computer readable medium of claim 9, wherein the detecting the request to display the first object comprises detecting the presence of a cursor above the first object during a predetermined period of time.

16. (canceled)

17. A system comprising:
a memory configured to:
store an image; and
a processor configured to:
cause the image to be displayed on a user device;
detect a request to display a first object that is within the image and obscured by a second object displayed over the first object;
determine, based on the detection of the request to display the first object, a size of the first object;
determine a size of a second image based on the size of the first object;
select a shape, from among multiple shapes, for the second image based on the first object;
generate the second image comprising the first object, wherein the second image is sized to fit into the selected shape; and
display the second image over the second object and over the first object that is within the displayed image.

18. The system of claim 17, wherein the second object is a tag associated with a third object in the image.

19. The system of claim 18, wherein the first object is a face of an individual in the image.

20. The system of claim 19, wherein the second object is a tag associated with a second individual in the image.

21. The method of claim 1, wherein the detecting the request to display the first object comprises detecting a double-click on the first object.

22. The method of claim 4, further comprising identifying the face of the individual in the image using facial recognition techniques.

23. The method of claim 1, wherein the second object is an advertisement associated with the first object.
